(19) United States
(12) Patent Application Publication
(10) Pub. No.: US 2026/0099117 A1
(43) Pub. Date: Apr. 9, 2026

(54) FIXING DEVICE AND IMAGE FORMING APPARATUS

(71) Applicant: CANON KABUSHIKI KAISHA, Tokyo (JP)

(72) Inventor: YUSAKU IWASAWA, Shizuoka (JP)

(21) Appl. No.: 19/347,489

(22) Filed: Oct. 1, 2025

(30) Foreign Application Priority Data
Oct. 7, 2024 (JP) 2024-175930

(51) Int. Cl. G03G 15/20

(52) U.S. Cl. CPC G03G 15/2053; G03G 15/2064; G03G 2215/2025

(57) ABSTRACT

Provided is a rotatable body that includes a plurality of heating elements that are ring-shaped and separated in an axis direction to have gaps between adjacent heating elements, and a sliding contact portion that includes a groove portion which extends in a direction intersecting a rotational direction of the rotatable body, through which lubricant can pass.

### BACKGROUND

### Field of the Technology

The present disclosure relates to a fixing device that fixes a toner image to a recording material, and an image forming apparatus including the same.

### Description of the Related Art

A fixing device mounted on an electrophotographic copying machine or printer that uses an electromagnetic induction heating method is generally known. For example, a fixing device including a fixing film having a conductive layer, a magnetic core provided in the inner space of the fixing film, and a spiral coil wound around the magnetic core is discussed in Japanese Patent Laid-Open No. 2014-026267. In this fixing device, if an alternating magnetic field is generated by an alternating current flowing through the coil, a circling current flows through a heat generation layer of the fixing film according to the principle of electromagnetic induction.

On the other hand, in a fixing device using an electromagnetic induction heating method, if a damaged portion such as a crack, a cleavage, or the like (a groove or a thin portion) occurs in a fixing film, heat generation may concentrate on an end portion of the damaged portion, and temperature may locally rise. See Japanese Patent Laid-Open No. 2006-301562. There is a possibility that such a local rise in temperature may cause an image defect such as image unevenness or the like.

To prevent a rise in temperature due to such a damaged portion such as a crack, a cleavage, or the like, a fixing device using a fixing film formed of a plurality of divided heat generation layers obtained by electrically dividing a heat generation layer in an axis direction of a rotation shaft of the fixing film is discussed in Japanese Patent Laid-Open No. 2015-118232. In such fixing device, a magnetic field is formed in the axis direction of the fixing film, whereby the divided heat generation layers generate heat by induced currents. However, since the heat generation layers are divided, the amount of current that flows through each divided heat generation layer is small. Thus, even if a crack, a cleavage, or the like occurs in the fixing film, the amount of current going around to an end portion of the crack, the cleavage, or the like is reduced. Thus, it is possible to prevent a local rise in temperature.

However, as discussed in Japanese Patent Laid-Open No. 2015-118232, an issue may arise regarding an inner circumferential surface of the fixing film, to which lubricant such as grease, oil, or the like is applied, with a nip portion formation member being provided that slides in contact with the inner circumferential surface. Since the heat generation layer of the fixing film is composed of the plurality of divided heat generation layers divided in the axis direction, there is a possibility that temperature unevenness may occur in the lubricant in the axis direction.

Lubricant viscosity generally has temperature characteristics such that the higher the temperature is, the lower the viscosity tends to be. Thus, there is a possibility that viscosity unevenness of the lubricant may occur along the axis direction. When the fixing film comes into sliding contact with the nip portion formation member in a state where a predetermined load is applied to nip and a recording material is conveyed, the thickness of the lubricant (the thickness of the grease or the oil film thickness of the oil) that is present between the fixing film and the nip portion formation member depends on the viscosity of the lubricant. That is, if temperature unevenness occurs in the axis direction due to the divided heat generation layers of the fixing film, minute unevenness may also occur in the thickness of the lubricant. If such thickness unevenness of the lubricant in the axis direction occurs, an increase in the torque of the fixing device, the occurrence of stick-slip, abrasion of the inner circumferential surface of the fixing film, or the like may occur, and the life of the fixing device may be reduced.

### SUMMARY

The present disclosure provides a fixing device capable of preventing the occurrence of thickness unevenness of lubricant in the axis direction on the inner circumferential surface of a rotating body that heats a recording material, and an image forming apparatus including the same.

An aspect of the present disclosure provides a fixing device that includes a heating unit and an opposing member. The heating unit is configured to heat a recording material on which a toner image has been formed. The heating unit includes a rotatable body and a nip portion formation member including a sliding contact portion. An inner circumferential surface of the rotatable body is configured to slidingly contact the sliding contact portion. The opposing member is opposed to the rotatable body and is configured to rotate about a rotational axis extending in an axis direction, the opposing member and the rotatable body forming a nip portion with the nip portion formation member. The sliding contact portion of the nip portion formation member and the inner circumferential surface of the rotatable body are configured to include lubricant therebetween. The rotatable body includes a plurality of heating elements that are ring-shaped, with the plurality of heating elements being separated in the axis direction to form gaps between adjacent heating elements. The sliding contact portion includes a groove portion extending in a direction intersecting a rotational direction of the rotatable body. The groove portion is configured to allow passage of the lubricant.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic diagram illustrating a printer according to a first embodiment.

FIG. 2 is a cross-sectional view illustrating a fixing device.

FIG. 3A is a cross-sectional view illustrating a cross section of a region where a conductive layer of a fixing film is present, FIG. 3B is a cross-sectional view illustrating a cross section of a region where the conductive layer of the fixing film is not present, and FIG. 3C is a cross-sectional view illustrating a cross section parallel to a longitudinal direction of the fixing film.

FIG. 4 is a perspective view illustrating the fixing film, a magnetic core, and an exciting coil.

FIG. 5A is a cross-sectional view illustrating a cross section in the longitudinal direction of the fixing film and for describing a magnetic field and a current that flows through the conductive layer, and FIG. 5B is a perspective view for describing a magnetic field and a current that flows through the conductive layer.

FIG. 6A is a diagram illustrating placement of protruding portions according to the first embodiment viewed from a pressure roller, and FIG. 6B is a diagram illustrating placement of divided conductors.

FIG. 7A is a diagram illustrating a cross section of protruding shapes of the protruding portions according to the first embodiment viewed from a rotational direction, and FIG. 7B is a diagram illustrating a cross section of a contact state between the protruding portions and the fixing film viewed from the rotational direction.

FIG. 8A is a diagram illustrating placement of protruding portions viewed from the pressure roller according to a variation of the first embodiment, and FIG. 8B is a diagram illustrating placement of protruding portions viewed from the pressure roller according to another variation of the first embodiment.

FIG. 9A is a diagram illustrating placement of protruding portions viewed from a pressure roller according to a second embodiment, and FIG. 9B is a diagram illustrating placement of protruding portions viewed from the pressure roller according to a variation of the second embodiment.

FIG. 10A is a diagram illustrating placement of protruding portions viewed from a pressure roller according to a third embodiment, and FIG. 10B is a diagram illustrating placement of protruding portions viewed from the pressure roller according to a variation of the third embodiment.

FIG. 11A is a cross-sectional view of a fixing device according to a fourth embodiment, and FIG. 11B is a diagram illustrating placement of protruding portions viewed from a pressure roller according to the fourth embodiment.

### DESCRIPTION OF THE EMBODIMENTS

Embodiments according to the present disclosure will be described below with reference to the drawings. In the present disclosure, an “image forming apparatus” is not limited to a single-function printer having only a print function, and broadly includes an apparatus that forms an image on a recording material, such as a copying machine having a copy function, a multifunction peripheral having a plurality of functions, a commercial large-sized printing machine, and the like.

In the present disclosure, a “fixing device” broadly includes a device (an image heating device) that heats an image (a toner image) formed on a recording material by an electrophotographic process or the like, thereby fixing the image to the recording material. The fixing device may be placed to heat an image already fixed (primarily fixed) to a recording material again, thereby imparting gloss to the image.

### First Embodiment

### [Image Forming Apparatus]

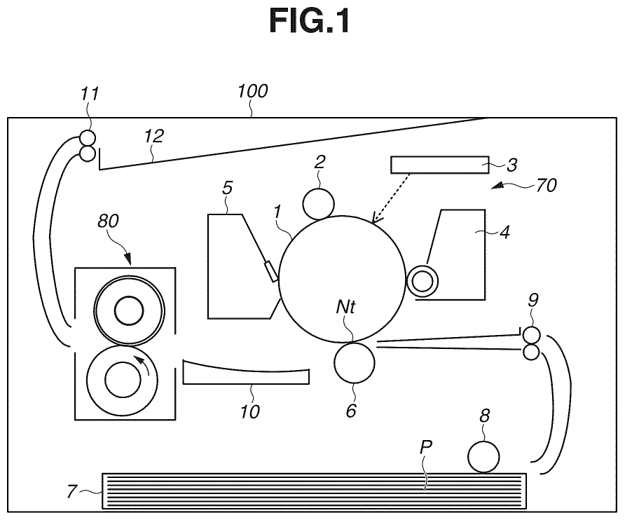

With reference to FIG. 1, the overall configuration of an image forming apparatus according to a first embodiment of the present disclosure is described.

FIG. 1 is a cross-sectional view illustrating the general configuration of a laser beam printer (hereinafter referred to as a “printer 100”) as an example of the image forming apparatus. The printer 100 executes an image forming operation for forming an image on a recording material P based on image information received from an external device such as a personal computer or the like. As the recording material P (a recording medium), various sheet materials different in size and material such as paper, e.g., plain paper and thick paper, a sheet material subjected to surface treatment, e.g., coated paper, a sheet material having a special shape, e.g., an envelope or index paper, plastic film, cloth, and the like can be used.

The printer 100 includes an image forming section 70 that forms an image (a toner image) on a recording material P by an electrophotographic process, and a fixing device 80 that fixes the image to the recording material P.

The image forming section 70 includes a photosensitive drum 1 as an image bearing member, a charging roller 2 as a charging section, a laser scanner 3 as an exposure section, and a development device 4 as a development section. The image forming section 70 includes a transfer roller 6 as a transfer section, and a cleaner 5 as a cleaning section. The photosensitive drum 1 is a photosensitive member molded into a cylindrical shape. The development device 4 includes a container 4a that stores toner as a developer, and a development roller 4b that bears the toner and supplies the toner to the photosensitive drum 1.

In the image forming operation, the photosensitive drum 1 is rotationally driven, and the charging roller 2 uniformly charges the surface of the photosensitive drum 1. A digital image signal generated based on image information by an image processing section included in the printer 100 is input to the laser scanner 3, whereby the laser scanner 3 exposes the photosensitive drum 1 by irradiating the photosensitive drum 1 with laser light and writes an electrostatic latent image according to the image information on the surface of the photosensitive drum 1.

The development device 4 supplies toner to the photosensitive drum 1 and develops the electrostatic latent image into a toner image.

In parallel with the creation of the toner image, a recording material P is conveyed. In a lower portion of the printer 100, a cassette 7 is accommodated so that the cassette 7 can be pulled out. In the cassette 7, recording materials P are stored in a stacked state. The recording materials P stored in the cassette 7 are fed one by one by a feeding roller 8 as a feeding section, and each recording material P is conveyed to a transfer nip portion Nt by a conveyance roller pair 9.

The transfer roller 6 transfers the toner image from the photosensitive drum 1 to the recording material P in the transfer nip portion Nt between the photosensitive drum 1 and the transfer roller 6. Foreign substances such as transfer residual toner remaining on the photosensitive drum 1 without being transferred to the recording material P and the like are removed by the cleaner 5.

The recording material P passing through the transfer nip portion Nt is sent to the fixing device 80. The fixing device 80 conveys the recording material P while heating and pressurizing the image (the toner image) on the recording material P, thereby fixing the image to the recording material P. The details of the fixing device 80 will be described below. The recording material P passing through the fixing device 80 is discharged to a discharge tray 12 by a discharge roller pair 11.

Although in the present embodiment an image forming section using a direct transfer method is described as the image forming section 70, the present disclosure is not limited to this. For example, an image forming section using an intermediate transfer method for primarily transferring a toner image from an image bearing member to an intermediate transfer member such as an intermediate transfer belt or the like and secondarily transferring the toner image from the intermediate transfer member to a recording material may be used. Although in the present embodiment, a configuration is described in which the image forming section 70 forms a monochrome image, the present disclosure is not limited to this. A configuration may be employed in which the image forming section 70 creates a color image using toner of a plurality of colors.

### [Fixing Device]

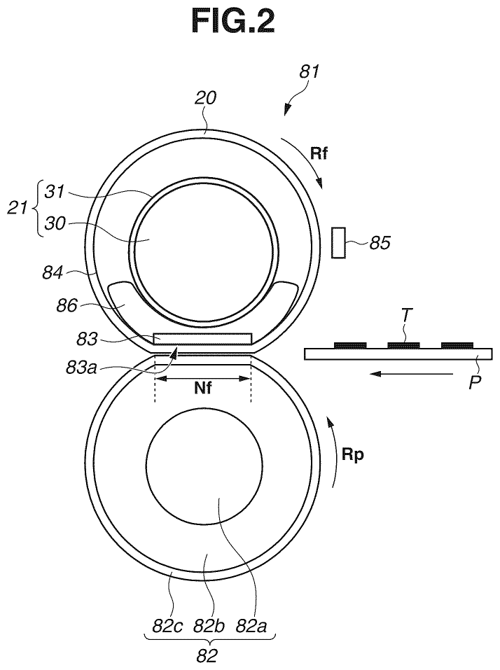

The fixing device 80 is described. The fixing device 80 according to the present embodiment is a fixing device using an electromagnetic induction heating method. FIG. 2 is a cross-sectional view illustrating the fixing device 80.

As illustrated in FIG. 2, the fixing device 80 includes a heating unit 81 that heats a recording material P on which a toner image is formed, a pressure roller 82 as an example of an opposing member, and a temperature sensor 85.

The heating unit 81 includes a fixing film 20 as an example of a rotatable rotating body, a magnetic field generation section 21 that forms an alternating magnetic field in a longitudinal direction LD of the fixing film 20, and a nip portion formation member 83. The fixing film 20 as a fixing member and a rotating body is formed of a tubular (endless) film having flexibility. The fixing film 20 is a fixing member that heats the image on the recording material P.

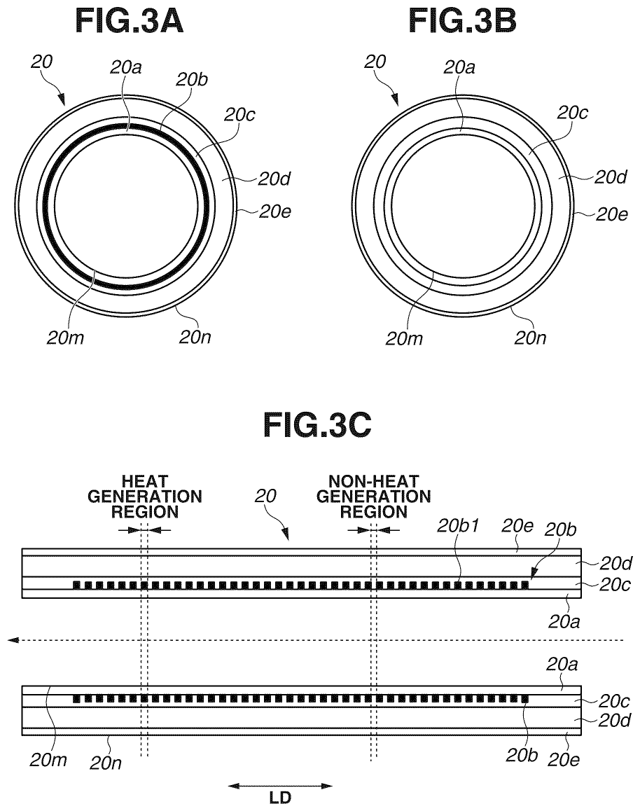

The magnetic field generation section 21 includes a magnetic core 30 as a magnetic body, and an exciting coil 31 as a coil. An alternating current flows through the exciting coil 31, whereby the magnetic field generation section 21 generates an alternating magnetic field and induces a current in an circumferential direction of a conductive layer 20b (see FIG. 3C) of the fixing film 20 by the alternating magnetic field.

The nip portion formation member 83 is supported by a supporting member 86. The supporting member 86 is a longitudinal member extending in the longitudinal direction LD and restricts the rotational position of the fixing film 20 by being in contact with an inner circumferential surface of the fixing film 20 upstream and downstream of the nip portion formation member 83 in a rotational direction Rf of the fixing film 20. The nip portion formation member 83 includes an approximately planar sliding contact portion 83a that comes into sliding contact with the inner circumferential surface of the fixing film 20. The nip portion formation member 83 forms a fixing nip portion Nf as an example of a nip portion between the fixing film 20 and the pressure roller 82 across the fixing film 20 between the nip portion formation member 83 and the pressure roller 82.

A metal, such as aluminum or the like, or a heat-resistant resin such as polyphenylene sulfide (PPS), a liquid crystal polymer (LCP), or the like may be used as the material of the nip portion formation member 83. To ensure the sliding contact properties of the nip portion formation member 83 with the fixing film 20, surface treatment, fluororesin coating, or the like may be performed on the sliding contact portion 83a. In the present embodiment, the nip portion formation member 83 obtained by using aluminum as a base material and performing alumite treatment on the sliding contact portion 83a is applied. The shape of the sliding contact portion 83a, which is a feature of the present embodiment, will be described below.

The pressure roller 82 is opposed to the fixing film 20 and rotates about a rotational axis extending in the longitudinal direction LD. The pressure roller 82 abuts the nip portion formation member 83 through the fixing film 20 and forms the fixing nip portion Nf with the nip portion formation member 83 between the pressure roller 82 and the sliding contact portion 83a of the nip portion formation member 83. The pressure roller 82 includes a metal core 82a, an elastic layer 82b formed on the outer surface of the metal core 82a, and a release layer 82c formed on the outer surface of the elastic layer 82b. The outer diameter of the pressure roller 82 according to the present embodiment is 30 mm.

Lubricant 84 is present between the sliding contact portion 83a of the nip portion formation member 83 and the inner circumferential surface of the fixing film 20. The lubricant 84 is applied to the inner circumferential surface of the fixing film 20. The lubricant 84 is present between the sliding contact portion 83a of the nip portion formation member 83 and the inner circumferential surface of the fixing film 20 and maintains excellent sliding contact properties between the nip portion formation member 83 and the fixing film 20. A lubricating oil or a grease having heat resistance as the lubricant 84 may be used. Silicone oil, perfluoropolyether (PFPE), fluorine grease obtained by adding a thickener to PFPE, or the like as the lubricant 84 may be used. In the present embodiment, as the lubricant 84, heat-resistant fluorine grease MOLYKOTE HP-300 (DuPont Toray Specialty Materials K.K.) is used, and 500 mg of the lubricant 84 is applied to the inner circumferential surface of the fixing film 20.

Each of the fixing film 20, the magnetic core 30, the pressure roller 82, and the nip portion formation member 83 is a longitudinal member in which the axis direction of a rotation shaft of the pressure roller 82 is the longitudinal direction LD (see FIG. 3C). That is, it can also be said that the longitudinal direction LD is the generatrix direction or the axis direction of the fixing film 20. Each of the lengths of the fixing film 20, the magnetic core 30, the pressure roller 82, and the nip portion formation member 83 in the longitudinal direction LD is longer than the maximum width of a recording material P that can be conveyed to the fixing device 80.

The fixing device 80 includes a frame that supports both end portions in the longitudinal direction LD of the supporting member 86. The frame supports a shaft portion of the metal core 82a of the pressure roller 82 so that the shaft portion can rotate through bearing members. The pressure roller 82 is pressed toward the nip portion formation member 83 by a biasing member such as a pressurization spring or the like. In the present embodiment, the biasing member pressurizes the bearing members provided in both end portions of the pressure roller 82 with a pressing force having a total pressure of approximately 196 N to 392 N (approximately 20 kgf to 40 kgf). Consequently, the elastic layer 82b of the pressure roller 82 is crushed and elastically deformed, and the surface of the fixing film 20 and the surface of the pressure roller 82 form the fixing nip portion Nf having a predetermined width.

Although in the present embodiment, the pressure roller 82 is biased toward the nip portion formation member 83, the present disclosure is not limited to this. For example, the nip portion formation member 83 may be biased toward the pressure roller 82 by a biasing member.

Next, the fixing film 20 according to the present embodiment is described in detail. The fixing film 20 is formed into a cylindrical shape having a diameter of 10 to 100 mm. In the present embodiment, the fixing film 20 having an outer diameter of 30 mm is used. FIG. 3A is a cross-sectional view illustrating a cross section of a region where a conductive layer 20b of the fixing film 20 is present (hereinafter referred to as a “heat generation region”). FIG. 3B is a cross-sectional view illustrating a cross section of a region where the conductive layer 20b of the fixing film 20 is not present (hereinafter referred to as a “non-heat generation region”). FIG. 3C is a cross-sectional view illustrating a cross section parallel to the longitudinal direction LD of the fixing film 20.

As illustrated in FIG. 3C, in the fixing film 20, heat generation regions and non-heat generation regions are intermittently present in the longitudinal direction LD. That is, in the fixing film 20, the heat generation regions and the non-heat generation regions are alternately provided in the longitudinal direction LD.

In the heat generation regions, as illustrated in FIG. 3A, the fixing film 20 has a layered structure including a base layer 20a, a conductive layer 20b, a protection layer 20c, an elastic layer 20d, and a release layer 20e. The base layer 20a, the conductive layer 20b, the protection layer 20c, the elastic layer 20d, and the release layer 20e are laminated in this order from an inner circumferential surface side to an outer circumferential surface side in the thickness direction of the fixing film 20. Reference numeral 20m denotes an inner circumferential surface of the fixing film 20 and reference numeral 20n denotes an outer circumferential surface of the fixing film 20.

As the material of the base layer 20a, a substance having nonmagnetic properties, a high volume electrical resistivity, and an excellent heat resistance is suitable. For example, the material of the base layer 20a is a heat-resistant resin typified by polyimide (PI), polyamide-imide (PAI), or the like, a fiber-reinforced plastic typified by a carbon fiber-reinforced plastic (CFRP), a glass fiber-reinforced plastic (GFRP), or the like, or the like. In a case where a heat-resistant resin is used for the base layer 20a, the thickness of the base layer 20a facilitates the obtaining of the strength of the fixing film 20, the sliding contact properties of the fixing nip portion Nf, and the rotational stability of the fixing film 20, and be 20 μm to 200 μm. In the present embodiment, the base layer 20a is formed of polyimide (PI), and the thickness of the base layer 20a is 50 μm.

As the material of the conductive layer 20b formed on the outer surface of the base layer 20a, for example, a metal having a low volume electrical resistivity, such as gold, silver, copper, iron, platinum, tin, stainless steel (SUS), titanium, aluminum, nickel, or the like, is suitable. In the present embodiment, as the material of the conductive layer 20b, copper having a volume electrical resistivity of 1.7×10-8 Ωm (room temperature) is used, and the thickness of the conductive layer 20b is 3 μm. The volume electrical resistivity and the thickness are merely examples, and are not limited to these. As illustrated in FIG. 3C, the conductive layer 20b is formed of a plurality of divided conductors 20b1 (divided conductive layers) electrically separated in the longitudinal direction LD. Each of the divided conductors 20b1 is formed into a ring shape parallel to the rotational direction Rf. The plurality of divided conductors 20b1 is an example of a plurality of heating elements, is divided in the longitudinal direction LD to have gaps between each other in the longitudinal direction LD, and heats the fixing film 20.

An example of a method for forming the conductive layer 20b is described below. First, a coating material including microparticles of the above metal and a polyimide precursor solution is prepared, and the coating material is applied to the outer surface of the base layer 20a by a method such as a blade, screen printing, or the like, thereby forming a coated film. When the coating material is applied to the outer surface of the base layer 20a, a division portion in which the conductive layer 20b is electrically divided at predetermined intervals in the longitudinal direction LD is formed in advance in the base layer 20a by a technique such as a general masking process or the like. Then, imidization is progressed by gradually heating and drying the coated film to approximately 300° C. to 500° C., the base layer 20a and the coated film are firmly bonded together, and the plurality of divided conductors 20b1 electrically divided in the longitudinal direction LD is formed. Instead of the above technique, after the above metal is plated on the outer surface of the base layer 20a, the divided conductors 20b1 may be formed by a technique such as laser etching, chemical etching, or the like.

On the outer surface of the conductive layer 20b, the protection layer 20c is formed for the purpose of protecting the divided conductors 20b1. As the material of the protection layer 20c, similarly to the base layer 20a, a substance having nonmagnetic properties, a high volume electrical resistivity, and an excellent heat resistance is suitable. For example, the material of the protection layer 20c is a heat-resistant resin typified by polyimide (PI), polyamide-imide (PAI), or the like, a fiber-reinforced plastic typified by a carbon fiber-reinforced plastic (CFRP), a glass fiber-reinforced plastic (GFRP), or the like, or the like. The thickness of the protection layer 20c may be 20 μm to 200 μm, which is a thickness that facilitates the obtaining of the rotational stability of the fixing film 20. In the present embodiment, the protection layer 20c is formed of polyimide (PI), and the thickness of the protection layer 20c is 50 μm.

On the outer surface of the protection layer 20c, the elastic layer 20d composed of a heat-resistant elastic body such as silicone rubber or the like is formed. In the present embodiment, the elastic layer 20d is formed of excellent thermal conductive silicone rubber, and the thickness of the clastic layer 20d is 200 μm.

On the outer surface of the elastic layer 20d, the release layer 20e is formed for the purpose of preventing the attachment of toner to the surface of the fixing film 20 and the occurrence of an image defect. As the release layer 20e, a material having an excellent non-adhesiveness is suitable. For example, tetrafluoroethylene-perfluoroalkyl vinyl ether (PFA) may be used. Alternatively, polytetrafluoroethylene (PTFE), tetrafluoroethylene-hexafluoropropylene (FEP), tetrafluoroethylene-ethylene (ETFE), or the like may be used as the release layer 20e. In the present embodiment, the release layer 20c is formed of PFA, and the thickness of the release layer 20c is 15 μm.

On the other hand, in the non-heat generation regions, as illustrated in FIG. 3B, the fixing film 20 has a layered structure including the base layer 20a, the protection layer 20c, the elastic layer 20d, and the release layer 20c. In the fixing film 20, the conductive layer 20b is not present in the non-heat generation regions. The details of the division pattern of the conductive layer 20b will be described below.

Although in the present embodiment, the elastic layer 20d is provided between the protection layer 20c and the release layer 20e, the present disclosure is not limited to this. For example, the elastic layer 20d may be omitted, and the protection layer 20c and the release layer 20e may be adjacent to each other. A primer layer may be provided for the purpose of strengthening the adhesiveness between layers. On the inner circumferential side of the base layer 20a, a layer forming the inner surface of the fixing film 20 may be provided.

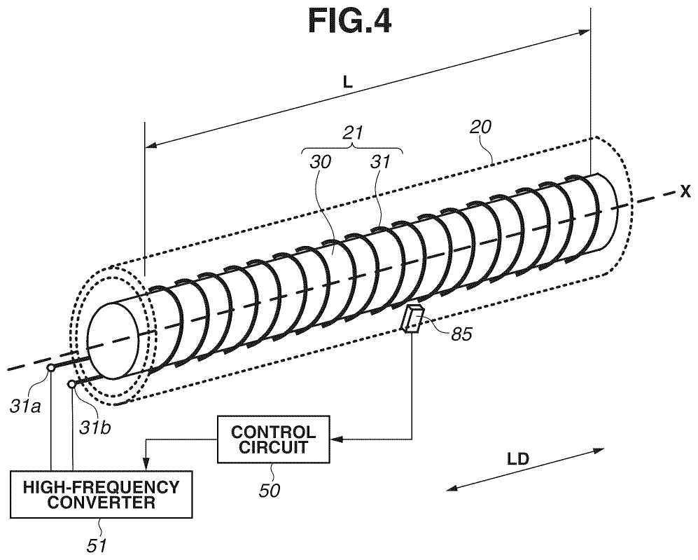

Next, the magnetic core 30 and the exciting coil 31 provided in the inner space of the fixing film 20 are described. FIG. 4 is a perspective view illustrating the fixing film 20, the magnetic core 30, and the exciting coil 31. The magnetic core 30 has a columnar shape extending in the longitudinal direction LD and is placed almost in the center of the fixing film 20 by a fixing method. The magnetic core 30 functions as a member that induces a line of magnetic force (a magnetic flux) due to an alternating magnetic field generated by the exciting coil 31 to the inner space of the fixing film 20 and forms a path for the line of magnetic force (a magnetic path).

The magnetic core 30 may be formed of a material having a small hysteresis loss and a high relative magnetic permeability. For example, an oxide having a high magnetic permeability, such as calcined ferrite, a ferrite resin, an amorphous alloy, permalloy, or the like, or a strong magnetic body composed of an alloy material as the material of the magnetic core 30 may be used. The magnetic core 30 may be formed into a shape with ends, for example, having a length of 200 mm to 300 mm in the longitudinal direction LD, the diameter of the magnetic core 30 be in the range where the magnetic core 30 can be accommodated inside the fixing film 20, and the cross-sectional area of the magnetic core 30 be maximized. In the present embodiment, as the magnetic core 30, calcined ferrite having a length of 240 mm and a diameter of 15 mm is used. The shape of the magnetic core 30 is not limited to a columnar shape, and a prism shape or the like can also be selected.

Although in the present embodiment, a configuration is employed in which an open magnetic path is formed by placing the magnetic core 30 only in the inner space of the fixing film 20, the present disclosure is not limited to this. For example, a configuration may be employed in which a closed magnetic path is formed by disposing a magnetic core to circle around the fixing film 20 outside the fixing film 20.

The exciting coil 31 forms a spiral-shaped portion L by spirally winding a single conductive wire of a copper wire material covered with heat-resistant polyamide-imide and having a diameter of 1 mm to 2 mm by approximately 10 turns to 30 turns as the number of turns around the magnetic core 30 about a spiral axis X. The spiral axis X extends almost parallel to the longitudinal direction LD. In the spiral-shaped portion L, the intervals between coils (conductive wires) are equal, and the number of turns is 18 turns in the present embodiment. If a high-frequency current (an alternating current) is applied from a high-frequency converter 51 to the exciting coil 31 via power feeding contact portions 31a and 31b, an alternating magnetic field (a magnetic field) is generated in the longitudinal direction LD of the fixing film 20.

### [Heat Generation Principle of Fixing Film]

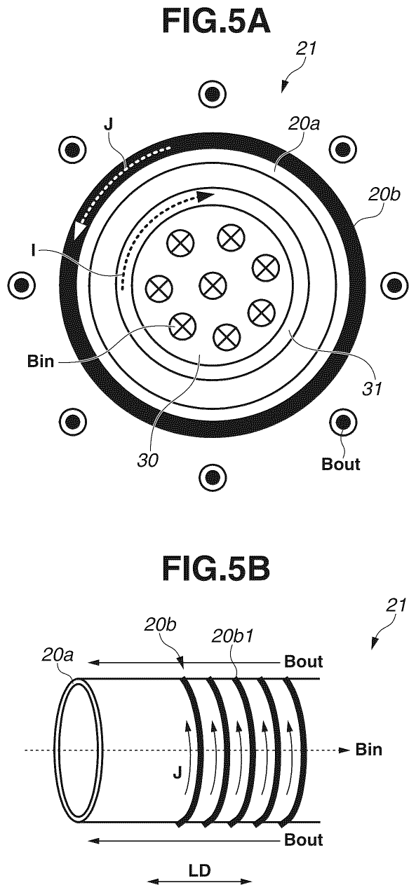

With reference to FIGS. 5A and 5B, the heat generation principle of the fixing film 20 is described. FIG. 5A is a cross-sectional view illustrating a cross section in the longitudinal direction LD of the fixing film 20 and for describing a magnetic field and a current that flows through the conductive layer 20b. FIG. 5B is a perspective view for describing a magnetic field and a current that flows through the conductive layer 20b. For case of description and conciseness, the protection layer 20c, the elastic layer 20d, and the release layer 20e are not illustrated in FIGS. 5A and 5B.

FIG. 5A illustrates an example where the magnetic core 30, the exciting coil 31, and the conductive layer 20b are placed in concentric circles from the center of the fixing film 20. In FIG. 5A, a line of magnetic force toward the depth direction in FIG. 5A is simulated as Bin (“x” in “o”), and a line of magnetic force toward the near direction in FIG. 5A is simulated as Bout (“.” in “o”).

As illustrated in FIG. 5A, at the moment when a current is increasing in the direction of an arrow I in the exciting coil 31, lines of magnetic force Bin toward the depth direction in FIG. 5A are formed and lines of magnetic force Bout returning in the near direction outside the fixing film 20 are formed in a magnetic path. When such lines of magnetic force are formed, an induced electromotive force is applied to the entire region in the circumferential direction of the conductive layer 20b to cancel out the lines of magnetic force, and a current in the direction of an arrow J that circles around the conductive layer 20b flows (hereinafter, this current is referred to as a “circling current”).

Since the induced electromotive force is applied in the circling direction of the conductive layer 20b, the circling current uniformly flows inside the conductive layer 20b. Then, lines of magnetic force generated by the magnetic core 30 repeat generation and disappearance and direction reversal by a high-frequency current that flows through the exciting coil 31. Thus, the circling current flows while repeating generation and disappearance and direction reversal in synchronization with the high-frequency current. If a current flows through the conductive layer 20b, Joule heat is generated in the conductive layer 20b due to the electrical resistance of the material (the metal) of the conductive layer 20b.

Since lines of magnetic force generated by the magnetic core 30 are generated parallel to the longitudinal direction LD of the fixing film 20, the circling current flows in the rotational direction of the fixing film 20. Thus, as illustrated in FIG. 5B, the circling current in the direction of the arrow J flows through each portion into which the conductive layer 20b is electrically divided in the fixing film 20. As described above, in the fixing film 20 according to the present embodiment, a high-frequency current is applied to the exciting coil 31, whereby an induced current is generated in the divided conductive layer 20b (the divided conductors 20b1), and the conductive layer 20b (the divided conductors 20b1) generates heat. That is, each of the divided conductors 20b1 is a conductor that generates heat due to an induced electromotive force if an alternating magnetic field is generated.

### [Fixing Operation]

If the image forming operation of the printer 100 is started, the fixing device 80 performs electromagnetic induction heating on the fixing film 20 based on the heat generation principle according to a predetermined timing. As illustrated in FIG. 2, the fixing device 80 rotates the pressure roller 82 in a rotational direction Rp by the rotational driving of a motor. The fixing film 20 rotates in the rotational direction Rf by following the rotation of the pressure roller 82 while the inner circumferential surface of the fixing film 20 is in contact with the sliding contact portion 83a of the nip portion formation member 83.

As illustrated in FIG. 4, the high-frequency converter 51 supplies a high-frequency current to the exciting coil 31 via the power feeding contact portions 31a and 31b. A control circuit 50 controls the high-frequency converter 51 based on the detection temperature of the temperature sensor 85 provided in a central portion in the longitudinal direction LD of the fixing film 20. Consequently, electromagnetic induction heating may be performed on the fixing film 20 while maintaining and adjusting the surface temperature of the fixing film 20 at a predetermined target temperature (approximately 150° C. to 200° C.). Then, as illustrated in FIG. 2, a recording material P bearing an unfixed toner image T (an image) is nipped and conveyed in the fixing nip portion Nf, whereby heat and pressure are applied to the toner image T, and the toner image T is fixed to the recording material P.

### [Sliding Contact Portion of Nip Portion Formation Member]

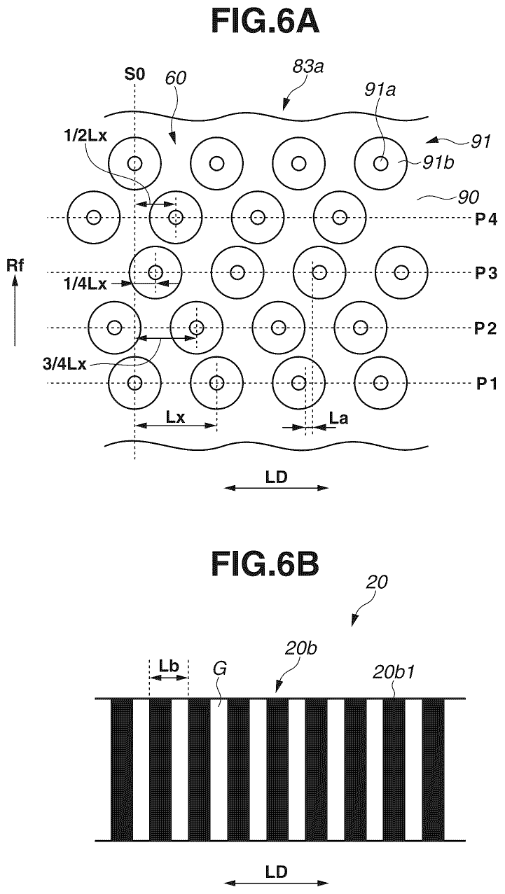

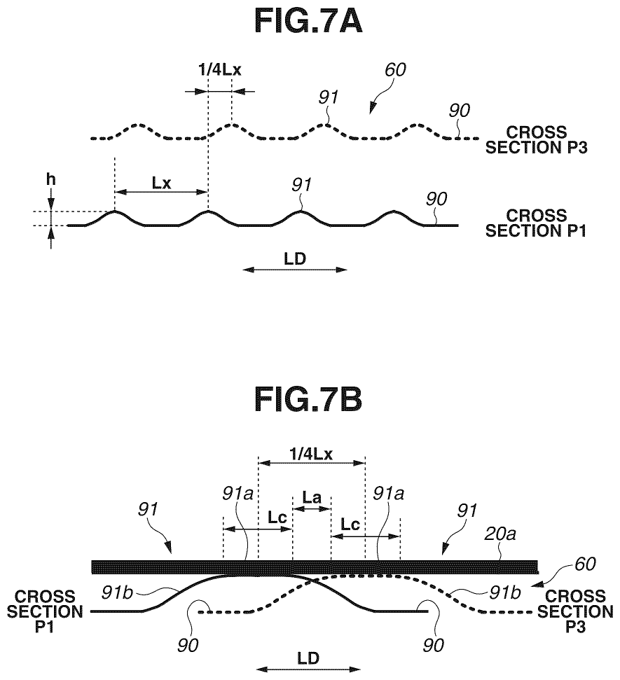

Next, with reference to FIGS. 6A to 7B, the shape of the sliding contact portion 83a of the nip portion formation member 83 is described. As illustrated in FIG. 6A, the sliding contact portion 83a includes a base surface 90 opposed to the fixing film 20, and a plurality of protruding portions 91 that protrudes from the base surface 90 toward the pressure roller 82 and comes into contact with the fixing film 20. In the present embodiment, the plurality of protruding portions 91 is provided on the base surface 90 of the sliding contact portion 83a, and the interval between protruding portions 91 in the longitudinal direction LD of the fixing film 20 is narrower than the pitch of divided conductors 20b1. The purpose of this is to prevent the occurrence of thickness unevenness of the lubricant 84 in the longitudinal direction LD due to the divided conductors 20b1 of the fixing film 20. The configuration of the protruding portions 91 is described in detail below.

As illustrated in FIG. 3C, the fixing film 20 according to the present embodiment includes the intermittent divided conductors 20b1 in the longitudinal direction LD. That is, the heat generation regions where the divided conductors 20b1 are present and the non-heat generation regions where the divided conductors 20bl are not present are alternately present in the longitudinal direction LD of the fixing film 20, and temperature unevenness may occur. On the release layer 20e side of the fixing film 20 where the fixing film 20 comes into contact with a recording material P, temperature unevenness that occurs due to the divided conductors 20bl is thermally diffused in the protection layer 20c and the elastic layer 20d, and therefore, an image defect due to temperature unevenness is less likely to occur in a toner image on the recording material P.

In contrast, on the base layer 20a side where the fixing film 20 comes into contact with the nip portion formation member 83, only the base layer 20a is present between the divided conductors 20b1 and the nip portion formation member 83, and therefore, a thermal diffusion effect is small, and temperature unevenness may occur. Thus, temperature unevenness may occur in the lubricant 84 that is in contact with the base layer 20a, and viscosity unevenness of the lubricant 84 may occur. As a result, thickness unevenness of the lubricant 84 may occur.

In view of the friction between the fixing film 20 and the nip portion formation member 83 based on the Stribeck curve theory, a hydrodynamic lubrication state is a state where the thickness of the lubricant 84 is thick and the hydrodynamic pressure force of the lubricant 84 supports the load. If, however, thickness unevenness occurs in the lubricant 84 as described above, the hydrodynamic lubrication state may transition to a mixed lubrication state or a boundary lubrication state in a region where the lubricant 84 is thin. Consequently, the fixing film 20 and the nip portion formation member 83 partially come into direct contact with each other, whereby excellent sliding contact properties may be less likely to be ensured. Particularly, in a case where the number of passed sheets in the printer 100 is great and the rotation time of the fixing film 20 is long, the total amount of the lubricant 84 decreases. Thus, if thickness unevenness of the lubricant 84 as described above occurs, an increase in the torque of the fixing device 80, the occurrence of stick-slip, abrasion of the inner surface of the fixing film 20, or the like may occur, and the lengthening of the life of the fixing device 80 may be inhibited.

Accordingly, in the present embodiment, to prevent the occurrence of thickness unevenness of the lubricant 84 due to the divided conductors 20b1, the plurality of protruding portions 91 is provided in the sliding contact portion 83a of the nip portion formation member 83. Consequently, the protruding portions 91 agitate the lubricant 84 in the longitudinal direction LD and level out thickness unevenness of the lubricant 84 in the longitudinal direction LD in the sliding contact portion 83a according to the rotation of the fixing film 20.

The protruding portions 91 according to the present embodiment are formed by embossing. That is, the protruding portions 91 are formed by performing chemical etching on aluminum as the base material of the nip portion formation member 83. For example, the sliding contact portion 83a is processed by a corrosive action due to chemicals on the aluminum base material masked according to the shapes and arrangement of the protruding portions 91. As a method for forming the protruding portions 91, pressing or laser processing may be used instead of this. In the present embodiment, chemical etching is performed on aluminum as the base material, and the shapes and arrangement of the protruding portions 91 are formed in the sliding contact portion 83a, and alumite treatment is then performed.

Next, with reference to FIG. 6A, the arrangement of the protruding portions 91 in the sliding contact portion 83a according to the present embodiment is described in detail. FIG. 6A is a diagram illustrating the arrangement of the protruding portions 91 provided in the sliding contact portion 83a of the nip portion formation member 83 and is a diagram of the sliding contact portion 83a viewed from the pressure roller 82 side. In the present embodiment, in the sliding contact portion 83a, each of the plurality of mountain-shaped protruding portions 91 is placed in the form of an island independently placed at intervals in the longitudinal direction LD and the rotational direction Rf of the fixing film 20. Each of the protruding portions 91 is formed in an approximately circular shape when viewed from the pressure roller 82 side. As illustrated in FIG. 6A, the protruding portions 91 are disposed at equal intervals with a pitch Lx along the longitudinal direction LD. In the present embodiment, as an example, the pitch Lx is 1000 μm.

In the rotational direction Rf of the fixing film 20, the plurality of protruding portions 91 is disposed while being shifted in the longitudinal direction LD. As illustrated in FIG. 6A, protruding portions 91 in a straight line P1 along the longitudinal direction LD are disposed at equal intervals with the pitch Lx with a reference position S0 in the longitudinal direction LD as a point of origin. In contrast, protruding portions 91 in a straight line P2, adjacent to the protruding portions 91 on the straight line P1 in the rotational direction Rf, are disposed at equal intervals with the pitch Lx from a position shifted by ¾ of Lx (=750 μm) from the reference position S0 in the longitudinal direction LD. Protruding portions 91 in a straight line P3 are disposed at equal intervals with the pitch Lx from a position shifted by ¼ of Lx (=250 μm) from the reference position S0 in the longitudinal direction LD. Protruding portions 91 in a straight line P4 are disposed at equal intervals with the pitch Lx from a position shifted by ½ of Lx (=500 μm) from the reference position S0 in the longitudinal direction LD. As described above, in the sliding contact portion 83a according to the present embodiment, the arrangement of four protruding portions 91 each shifted in the longitudinal direction LD by ¼ of Lx (=250 μm) along the rotational direction Rf is periodically disposed.

Although the arrangement of the plurality of protruding portions 91 is made based on the position shifted by ¾ of Lx from the reference position S0 in the straight line P2, the position shifted by ¼ of Lx from the reference position S0 in the straight line P3, and the position shifted by ½ of Lx from the reference position S0 in the straight line P4, the present disclosure is not limited to this. For example, a position shifted by ¼ of Lx from the reference position S0 in the straight line P2, a position shifted by ½ of Lx from the reference position S0 in the straight line P3, and a position shifted by ¾ of Lx from the reference position S0 in the straight line P4 may be used. Alternatively, other amounts of shift may be used. Alternatively, the number of straight lines is not limited to four, and two or more straight lines only need to be present because the straight lines can be placed by being shifted in the longitudinal direction LD.

In the present embodiment, the reason for disposing the protruding portions 91 by shifting the protruding portions 91 in the longitudinal direction LD along the rotational direction Rf is to agitate the lubricant 84 and solve thickness unevenness using the protruding portions 91. If the protruding portions 91 are not shifted in the longitudinal direction LD along the rotational direction Rf, regions that are constantly in contact with protruding portions 91 and regions that are not constantly in contact with protruding portions 91 occur at the pitch Lx on the inner circumferential surface of the fixing film 20. The amount of the lubricant 84 is small in the regions that are constantly in contact with protruding portions 91, and conversely, the amount of the lubricant 84 is great in the regions that are not constantly in contact with protruding portions 91. As described above, if the protruding portions 91 are not shifted in the longitudinal direction LD along the rotational direction Rf, thickness unevenness of the lubricant 84 may occur due to the protruding portions 91. Thus, in the present embodiment, the positions of the protruding portions 91 are placed by being shifted in the longitudinal direction LD along the rotational direction Rf.

Next, with reference to FIGS. 7A and 7B, the shapes of the protruding portions 91 and contact regions between the protruding portions 91 and the inner circumferential surface of the fixing film 20 are described. FIG. 7A is a diagram illustrating the shapes of the protruding portions 91 viewed from upstream in the rotational direction Rf of the fixing film 20 and the interval in the longitudinal direction LD between adjacent protruding portions 91. FIG. 7A illustrates a cross-sectional shape (a cross section P1) when the protruding portions 91 in FIG. 6A are cut along the straight line PI and viewed from upstream in the rotational direction Rf, and a cross-sectional shape (a cross section P3) when the protruding portions 91 in FIG. 6A are cut along the straight line P3 and viewed from upstream in the rotational direction Rf one above the other. As illustrated in FIG. 7A, the mountain-shaped protruding portions 91 are provided at equal intervals with the pitch Lx. Then, if the cross sections P1 and P3 viewed from upstream in the rotational direction Rf are compared with each other, the protruding portions 91 are shifted by intervals ¼ of the pitch Lx in the longitudinal direction LD.

A height h of the protruding portions 91 is set to be 5 μm to 100 μm according to the shapes of the protruding portions 91, taking into account the effect of leveling out the lubricant 84 and the contact pressure of the protruding portions 91 on the inner circumferential surface of the fixing film 20. In the present embodiment, the height h of the protruding portions 91 is 20 μm.

FIG. 7B illustrates a contact state between the protruding portions 91 and the fixing film 20. FIG. 7B is a diagram obtained by projecting the cross section P3 onto the cross section P1 when viewed from upstream in the rotational direction Rf of the fixing film 20. The far side of the plane of the paper is the downstream side in the rotational direction Rf. FIG. 7B illustrates the protruding portions 91 in an enlarged manner for describing the contact state with the fixing film 20. As illustrated in FIG. 7B, each of the protruding portions 91 is in contact with the base layer 20a on the inner circumferential surface of the fixing film 20 at a longitudinal width Lc on a contact surface 91a that is an end surface on the fixing film 20 side. The protruding portion 91 includes a sloping surface 91b continuously provided between the contact surface 91a and the base surface 90.

On the inner circumferential surface of the fixing film 20, an interval La between regions that are not in contact with protruding portions 91 is La=¼Lx-Lc. If the cross sections P2 and P4 are added to the cross sections P1 and P3, and all the protruding portions 91 on the sliding contact portion 83a are viewed from upstream in the rotational direction Rf of the fixing film 20, the protruding portions 91 are adjacent to each other at the interval La. In the present embodiment, the longitudinal width Lc of the contact surface 91a with the fixing film 20 is 150 μm, and therefore, the value of the interval La between regions that are not in contact with protruding portions 91 is 100 μm.

FIG. 6B is a diagram illustrating the placement of the divided conductors 20bl of the fixing film 20. As illustrated in FIG. 6B, in the fixing film 20, the plurality of divided conductors 20b1 is intermittently present at a pitch Lb along the longitudinal direction LD. In the present embodiment, the pitch Lb of divided conductors 20b1 is 500 μm. That is, the plurality of divided conductors 20bl is placed next to each other at the predetermined pitch Lb in the longitudinal direction LD. In FIG. 6B, divided conductors 20b1 are arranged with a gap G therebetween as illustrated in FIG. 6B.

In the present embodiment, the interval La between adjacent protruding portions 91 viewed from upstream in the rotational direction Rf of the fixing film 20 is set to be narrower than the pitch Lb of divided conductors 20b1 of the fixing film 20. That is, the interval La (=100 μm) between protruding portions 91 viewed from upstream in the rotational direction Rf of the fixing film 20 is narrower than the pitch Lb (=500 μm) of divided conductors 20b1 of the fixing film 20. As described above, the interval La between protruding portions 91 is narrower than the pitch Lb of divided conductors 20b1, whereby thickness unevenness of the lubricant 84 that occurs due to the divided conductors 20b1 is leveled out in the longitudinal direction LD by the protruding portions 91 of the sliding contact portion 83a according to the rotation of the fixing film 20. Consequently, unevenness of the thickness of the lubricant 84 may be solved.

If the interval La between protruding portions 91 is wider than the pitch Lb of divided conductors 20b1, a region where the leveling effect of the protruding portions 91 is not sufficiently produced may be present, and local thickness unevenness of the lubricant 84 may occur. In contrast, the interval La between protruding portions 91 is narrower than the pitch Lb of divided conductors 20b1, whereby it is possible to sufficiently produce the leveling effect of the protruding portions 91 in all regions. Thus, uneven thickness of the lubricant 84 that occurs due to the divided conductors 20bl is prevented.

The interval La between protruding portions 91 viewed from upstream in the rotational direction Rf of the fixing film 20 may be 0. For example, the pitch Lx according to the present embodiment may be 600 μm or less, and the arrangement of the protruding portions 91 may be such that the interval between protruding portions 91 is not present when viewed from upstream in the rotational direction Rf of the fixing film 20. Also in this case, the interval La between protruding portions 91 viewed from upstream in the rotational direction Rf of the fixing film 20 can be narrower than the pitch Lb of divided conductors 20b1 of the fixing film 20. Thus, uneven thickness of the lubricant 84 that occurs due to the divided conductors 20b1 is prevented.

In the present embodiment, the lubricant 84 flows between adjacent protruding portions 91, whereby the lubricant 84 is agitated and leveled out. That is, a groove portion 60 is formed between the base surface 90 and the plurality of protruding portions 91, and the lubricant 84 can pass through the groove portion 60. In this case, if the groove portion 60 has such a shape that the groove portion 60 extends only in the rotational direction Rf, the lubricant 84 is not sufficiently leveled out in the longitudinal direction LD. Thus, in the present embodiment, the groove portion 60 is formed into such a shape that the groove portion 60 extends in a direction intersecting the rotational direction Rf of the fixing film 20. Consequently, the lubricant 84 guided by passing through the groove portion 60 moves in the direction intersecting the rotational direction Rf and is leveled out in the longitudinal direction LD. In the present embodiment, as illustrated in FIG. 6A, the region of the base surface 90 and the sloping surfaces 91b, which are portions other than the contact surfaces 91a of the protruding portions 91 in the sliding contact portion 83a, forms the groove portion 60 as a whole. The lubricant 84 is moved by the groove portion 60 formed in the region of the base surface 90 and the sloping surfaces 91b.

In the present embodiment, as described above, the interval La (=100 μm) between protruding portions 91 viewed from upstream in the rotational direction Rf of the fixing film 20 is narrower than the pitch Lb (=500 μm) of divided conductors 20b1 of the fixing film 20. If this configuration is defined by the groove portion 60, the minimum width (the interval La) in the groove portion 60 is less than the pitch Lb (=500 μm) of divided conductors 20b1 when viewed in the rotational direction Rf.

### COMPARATIVE EXAMPLE

Next, a description is given of an evaluation experiment in which the effect of improving durability according to the present embodiment was confirmed. The effect was confirmed by comparing the nip portion formation member 83 according to the present embodiment (the first embodiment) in which the protruding portions 91 are provided in the sliding contact portion 83a as illustrated in FIG. 6A, and a nip portion formation member in which the protruding portions 91 are not provided in the sliding contact portion 83a as comparative example 1. The evaluation experiment was performed using a sheet passing endurance test, and conditions for the occurrence of stick-slip and the torque value of the fixing device 80 are compared between comparative example 1 and the first embodiment. The details of the endurance test are described below.

As sheet passing conditions, a continuous printing operation was performed at a sheet conveyance speed of 350 mm/sec (throughput was 65 sheets per minute) using GFC-081 (Canon Marketing Japan Inc.) as recording materials P. In the endurance test, the occurrence situation of stick-slip was confirmed every fifty thousand sheets as the number of passed sheets. The slower that the rotational speed of the fixing film 20 is, the more likely the thickness of the lubricant 84 is to be thin, and the more likely stick-slip is to occur. Thus, stick-slip was confirmed by individually driving the fixing device 80 in the state where recording materials P were not passed, and determining whether abnormal noise due to stick-slip was generated while changing the rotational speed of the fixing film 20 to 200, 150, 100, and 50 mm/sec. When the fixing device 80 was individually driven, temperature adjustment control was performed so that the surface temperature of the fixing film 20 was 200° C., based on the detection temperature of the temperature sensor 85.

Table 1 illustrates the results of the endurance test. Table 1 illustrates the occurrence situation of stick-slip after a predetermined number of sheets were passed in comparative example 1 and the first embodiment. In table 1, “Occurred” indicates that abnormal noise was observed, and “Not Occurred” indicates that no abnormal noise was observed.

TABLE 1

| | Comparative Example 1 | | | | First Embodiment | | | |
|---|---|---|---|---|---|---|---|---|
| | Rotational Speed of Fixing Film | | | | | | | |
| | 200 | 150 | 100 | 50 | 200 | 150 | 100 | 50 |
| | mm/sec | mm/sec | mm/sec | mm/sec | mm/sec | mm/sec | mm/sec | mm/sec |
| After | Not | Not | Not | Not | Not | Not | Not | Not |
| 50000 | Occurred | Occurred | Occurred | Occurred | Occurred | Occurred | Occurred | Occurred |
| Sheets Are | | | | | | | | |
| Passed | | | | | | | | |
| After | Not | Not | Not | Not | Not | Not | Not | Not |
| 100000 | Occurred | Occurred | Occurred | Occurred | Occurred | Occurred | Occurred | Occurred |
| Sheets Are | | | | | | | | |
| Passed | | | | | | | | |
| After | Not | Not | Not | Not | Not | Not | Not | Not |
| 150000 | Occurred | Occurred | Occurred | Occurred | Occurred | Occurred | Occurred | Occurred |
| Sheets Are | | | | | | | | |
| Passed | | | | | | | | |
| After | Not | Not | Not | Occurred | Not | Not | Not | Not |
| 200000 | Occurred | Occurred | Occurred | | Occurred | Occurred | Occurred | Occurred |
| Sheets Are | | | | | | | | |
| Passed | | | | | | | | |
| After | Not | Not | Occurred | Occurred | Not | Not | Not | Not |
| 250000 | Occurred | Occurred | | | Occurred | Occurred | Occurred | Occurred |
| Sheets Are | | | | | | | | |
| Passed | | | | | | | | |
| After | Not | Occurred | Occurred | Occurred | Not | Not | Not | Not |
| 300000 | Occurred | | | | Occurred | Occurred | Occurred | Occurred |
| Sheets Are | | | | | | | | |
| Passed | | | | | | | | |

As illustrated in table 1, in comparative example 1 where the sliding contact portion 83a did not include the protruding portions 91, stick-slip did not occur up to one hundred and fifty thousand sheets. However, when the fixing device 80 was driven at 50 mm/sec after two hundred thousand sheets were passed, a chattering noise due to stick-slip was confirmed. When the endurance was further advanced, a chattering noise due to stick-slip was confirmed at 100 mm/sec or less after two hundred and fifty thousand sheets were passed, and a chattering noise due to stick-slip was confirmed at 150 mm/sec or less after three hundred thousand sheets were passed. As described above, if stick-slip occurs in a low-speed region, abnormal noise due to stick-slip may be generated when printing is performed in a low-speed mode as in a case where printing is performed using thick paper or rough paper, or at a timing when the driving of the fixing device 80 is started or stopped.

In contrast, in the first embodiment, even when low-speed rotation was performed after three hundred thousand sheets were passed, abnormal noise due to stick-slip was not confirmed. In the present embodiment, it was confirmed that unevenness of the lubricant 84 was prevented and the occurrence of stick-slip was prevented by providing the protruding portions 91 at intervals narrower than the intervals between the divided conductors 20b1 of the fixing film 20 in the sliding contact portion 83a of the nip portion formation member 83.

The torque value of the fixing device 80 was also compared. When the torque of the fixing device 80 was measured in a case where the fixing device 80 was individually driven at 200 mm/sec after three hundred thousand sheets were passed in comparative example 1 and the first embodiment, the torque of the fixing device 80 was 6 kgf cm in comparative example 1, whereas the torque of the fixing device 80 was 4 kgf cm in the first embodiment. As described above, it was confirmed that in the present embodiment, the torque value after the endurance was also successfully reduced compared to comparative example 1, and excellent sliding contact properties are maintained between the fixing film 20 and the nip portion formation member 83 over a long period.

As is clear from the above evaluation experiment, in the present embodiment, unevenness of the lubricant 84 that occurred due to the divided conductors 20b1 was successfully prevented, whereby the occurrence of stick-slip was successfully prevented while the torque value after the endurance was successfully reduced. Thus, the durability of the fixing device 80 is improved.

As described above, based on the fixing device 80 according to the present embodiment, the sliding contact portion 83a includes the groove portion 60 which extends in a direction intersecting the rotational direction Rf and through which the lubricant 84 can pass. Consequently, thickness unevenness of the lubricant 84 is leveled out. Particularly, in the present embodiment, the groove portion 60 is formed by the protruding portions 91, and the interval La between adjacent protruding portions 91 viewed from upstream in the rotational direction Rf of the fixing film 20 is narrower than the pitch Lb of divided conductors 20b1 of the fixing film 20. Consequently, thickness unevenness of the lubricant 84 is leveled out, and the occurrence of thickness unevenness of the lubricant 84 in the longitudinal direction LD on the inner circumferential surface of the fixing film 20 is prevented. Thus, the life of the fixing device 80 is extended.

In the fixing device 80 according to the present embodiment, the protruding portions 91 are placed in the forms of independent islands in each of the longitudinal direction LD and the rotational direction Rf. Thus, the lubricant 84 is moved in a complex manner in a plurality of directions intersecting the rotational direction Rf between the protruding portions 91 and sufficiently leveled out.

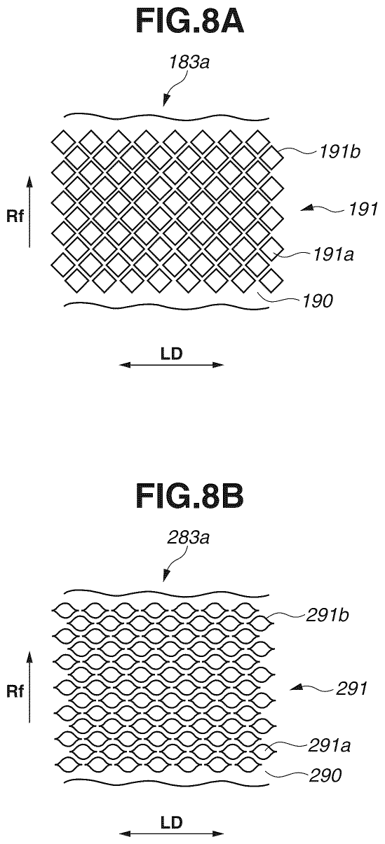

Although in the present embodiment, a case has been described where each of the protruding portions 91 has a mountain shape including the sloping surface 91b and is an approximately circular shape when viewed from the pressure roller 82, the present disclosure is not limited to this. For example, as illustrated in FIG. 8A, in a sliding contact portion 183a, protruding portions 191 may each have a protruding shape including a side surface 191b perpendicular to a base surface 190. In this case, a contact surface 191a may have a rectangular shape sloping by 45 degrees relative to the longitudinal direction LD when viewed from the pressure roller 82. Each of the contact surfaces 191a may have a square shape, and the protruding portions 191 may be placed by being shifted on a two-line cycle in the rotational direction Rf.

Alternatively, as illustrated in FIG. 8B, in a sliding contact portion 283a, protruding portions 291 may each have a protruding shape including a side surface 291b perpendicular to a base surface 290, and a contact surface 291a may have a scaly shape in which the ends of the contact surface 291a in the longitudinal direction LD are pointed when viewed from the pressure roller 82, and other portions of the contact surface 291a are rounded. Also in this case, the protruding portions 291 may be placed by being shifted on a two-line cycle in the rotational direction Rf.

Although in the present embodiment, the arrangement of the protruding portions 91 is a regular arrangement, the present disclosure is not limited to this. The arrangement of the protruding portions 91 may be a random placement so long as the interval La between adjacent protruding portions 91 viewed in the rotational direction Rf is narrower than the pitch Lb of divided conductors 20b1. Also in this case, since the interval La between adjacent protruding portions 91 viewed in the rotational direction Rf is narrower than the pitch Lb of divided conductors 20b1, thickness unevenness of the lubricant 84 is leveled out, similar to the above embodiment.

Although in the present embodiment, each of the divided conductors 20b1 is formed into a ring shape parallel to the rotational direction Rf, the present disclosure is not limited to this. For example, the ring-shaped divided conductors 20b1 may be arranged not parallel but inclined to the rotational direction Rf. Also in this case, if temperature unevenness occurs in the lubricant 84, the interval La between adjacent protruding portions 91 viewed in the rotational direction Rf is narrower than the pitch Lb of divided conductors 20b1, whereby temperature unevenness of the lubricant 84 is prevented.

Although in the present embodiment, a form has been described in which the shapes of the protruding portions 91 are provided in aluminum itself as the base material of the nip portion formation member 83, the present disclosure is not limited to this. For example, a sliding contact sheet may be provided between the nip portion formation member 83 and the fixing film 20, and the protruding portions 91 as described above may be provided in a sliding contact portion of the sliding contact sheet with the fixing film 20. In this case, for example, as the sliding contact sheet, a sliding contact sheet in which a base layer is formed of a heat-resistant resin such as polyimide (PI), polyamide-imide (PAI), or the like and a surface layer is coated with a fluororesin is used and subjected to heat embossing or the like, thereby forming protruding portions 91. The sliding contact sheet in which such protruding portions 91 are provided is fixed to the supporting member 86 upstream of the fixing nip portion Nf and is disposed by slipping the sliding contact sheet between the fixing film 20 and the nip portion formation member 83, whereby thickness unevenness of the lubricant 84 is also prevented.

Although in the present embodiment, a case has been described where the divided conductors 20b1 that generate heat by electromagnetic induction are applied as the plurality of heating elements, the present disclosure is not limited to this. For example, a heater divided in the longitudinal direction LD may be applied as the plurality of heating elements.

### Second Embodiment

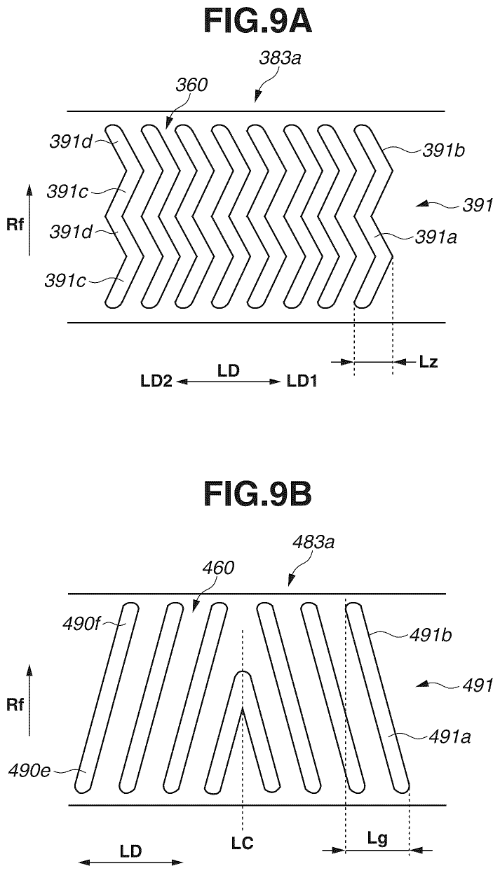

Next, a second embodiment of the present disclosure is described. The second embodiment is obtained by changing the pattern of the arrangement of the protruding portions 91 according to the first embodiment. Thus, components similar to those in the first embodiment are described by omitting the illustration of the components or designating the components by the same signs in the figures. The present embodiment is different from the first embodiment in that protruding portions 391 of a sliding contact portion 383a each have the shape of a continuous protruding portion 391 in the present embodiment, whereas the protruding portions 91 are arranged in the forms of islands in the first embodiment. With reference to FIG. 9A, the shapes of the protruding portions 391 of the sliding contact portion 383a according to the present embodiment are described. FIG. 9A is a diagram of the sliding contact portion 383a viewed from the pressure roller 82 side.

As illustrated in FIG. 9A, a sliding contact portion 383a includes a plurality of zigzag-shaped protruding portions 391 in the rotational direction Rf. In the present embodiment, each of the protruding portions 391 has a continuous shape in which the protruding portion 391 has intersection angles to the rotational direction Rf. Each of the protruding portions 391 includes a first straight portion 391c of which the downstream side in the rotational direction Rf is located further on one side LD1 in the longitudinal direction LD than the upstream side is, and a second straight portion 391d of which the downstream side in the rotational direction Rf is located further on the other side LD2 in the longitudinal direction LD than the upstream side is. Each of the first straight portion 391c and the second straight portion 391d is an example of a straight portion and is formed into a straight line extending in a direction intersecting both the longitudinal direction LD and the rotational direction Rf. In the present embodiment, a groove portion 360 is formed between the protruding portions 391.

As described above, the continuous protruding portions 391 each having intersection angles to the rotational direction Rf of the fixing film 20 are provided, whereby the lubricant 84 is diffused in the longitudinal direction LD according to the rotation of the fixing film 20. Thus, thickness unevenness of the lubricant 84 is levelled out. Also in such continuous protruding portions 391, the interval between adjacent protruding portions 391 viewed from upstream in the rotational direction Rf of the fixing film 20 is narrower than the pitch Lb of divided conductors 20b1 thereby eliminating a region where an insufficient leveling effect of the protruding portions 391.

In the present embodiment, a width Lz in the longitudinal direction LD of each of the protruding portions 391 is wider than the pitch Lb of divided conductors 20b1 of the fixing film 20. Consequently, in the fixing nip portion Nf, the protruding portions 391 may be placed so that at least parts of the protruding portions 391 overlap the plurality of divided conductors 20b1. Thus, the lubricant 84 is diffused beyond the intervals between the divided conductors 20b1. That is, each of the protruding portions 391 is placed so that at least a part of the protruding portion 391 overlaps two adjacent divided conductors 20b1 when viewed in a direction orthogonal to both the longitudinal direction LD and the rotational direction Rf. As described above, a continuous protruding portion 391 is positioned to extend over a plurality of divided conductors 20b1, providing an improved leveling out of thickness unevenness of the lubricant 84.

In the present embodiment, the divided conductors 20b1 are placed at intervals of 200 μm. Thus, if the width Lz in the longitudinal direction LD of each of the protruding portions 391 exceeds at least 200 μm, the protruding portion 391 may extend over a plurality of divided conductors 20b1. Thus, the leveling effect is produced. If, however, the width Lz in the longitudinal direction LD slightly exceeds 200 μm, the protruding portion 391 may not extend over a plurality of divided conductors 20b1 depending on the position of the protruding portion 391. Thus, the width Lz may be wider in the longitudinal direction LD, for example, wider than the pitch Lb. The width Lz in the longitudinal direction LD is wider than the total of the pitch Lb and an interval of 200 μm, whereby the protruding portion 391 can extend over a plurality of divided conductors 20b1 at any positions. Thus, further improvement of the leveling effect is extended.

Also in the present embodiment, the sliding contact portion 383a includes the groove portion 360 which extends in a direction intersecting the rotational direction Rf and through which the lubricant 84 can pass. Consequently, thickness unevenness of the lubricant 84 is leveled out. Particularly, in the present embodiment, the interval La between adjacent protruding portions 391 viewed from upstream in the rotational direction Rf of the fixing film 20 is narrower than the pitch Lb of divided conductors 20bl of the fixing film 20. Consequently, thickness unevenness of the lubricant 84 is leveled out, and the occurrence of thickness unevenness of the lubricant 84 in the longitudinal direction LD on the inner circumferential surface of the fixing film 20 is prevented. Thus, the life of the fixing device 80 is extended.

Although in the example illustrated in FIG. 9A, a case has been described where each of the protruding portions 391 includes four straight portions, the present disclosure is not limited to this. Two or more straight portions only need to be present. Instead of straight portions, for example, curved portions or the like may be employed.

Although in the present embodiment, a case has been described where the sliding contact portion 383a includes the zigzag-shaped protruding portions 391 each including a plurality of straight portions, the present disclosure is not limited to this. For example, as illustrated in FIG. 9B, a sliding contact portion 483a may include a plurality of slant-shaped protruding portions 491 in the rotational direction Rf of the fixing film 20. In this case, each of the protruding portions 491 is composed of a straight portion formed into a straight line extending in a direction intersecting both the longitudinal direction LD and the rotational direction Rf. As illustrated in FIG. 9B, the slant-shaped protruding portions 491 each having an intersection angle to the rotational direction Rf of the fixing film 20 are provided, to level out thickness unevenness of the lubricant 84 according to the rotation of the fixing film 20. In this case, a groove portion 460 is formed between the protruding portions 491.

The protruding portions 491 are placed symmetrically with respect to a center LC in the longitudinal direction LD of the nip portion formation member 83 and formed so that the protruding portions 491 come close to the center LC along the rotational direction Rf of the fixing film 20. That is, each of the protruding portions 491 includes an upstream end 490e and a downstream end 490f in the rotational direction Rf, and the downstream end 490f is located further on the center side of the sliding contact portion 483a in the longitudinal direction LD than the upstream end 490e is. Such slant-shaped protruding portions 491 are placed, whereby the effect of leveling out thickness unevenness of the lubricant 84 while moving the lubricant 84 close to the center LC in the longitudinal direction LD according to the rotation of the fixing film 20 is produced. Consequently, the amount of the lubricant 84 leaking out of both end portions in the longitudinal direction LD of the fixing film 20 is reduced and the amount of the lubricant 84 on the inner surface of the fixing film 20 is maintained over a long period. As a result, the durability is improved.

Also in such slant-shaped protruding portions 491, each of the protruding portions 491 may be positioned to extend over a plurality of divided conductors 20b1 in the fixing nip portion Nf. That is, providing the slant-shaped protruding portions 491 so that a width Lg in the longitudinal direction LD of each of the protruding portions 491 in the fixing nip portion Nf is wider than the pitch Lb of divided conductors 20b1 of the fixing film 20.

Also in such protruding portions 491 illustrated in FIG. 9B, the interval La between adjacent protruding portions 491 viewed from upstream in the rotational direction Rf of the fixing film 20 is narrower than the pitch Lb of divided conductors 20bl of the fixing film 20. Consequently, thickness unevenness of the lubricant 84 is leveled out, and the occurrence of thickness unevenness of the lubricant 84 in the longitudinal direction LD on the inner circumferential surface of the fixing film 20 is prevented. Thus, the life of the fixing device 80 is extended.

Although in the example illustrated in FIG. 9B, a case has been described where each of the protruding portions 491 has a linear shape, the present disclosure is not limited to this. Each of the protruding portions 491 may have a curved shape or the like.

### Third Embodiment

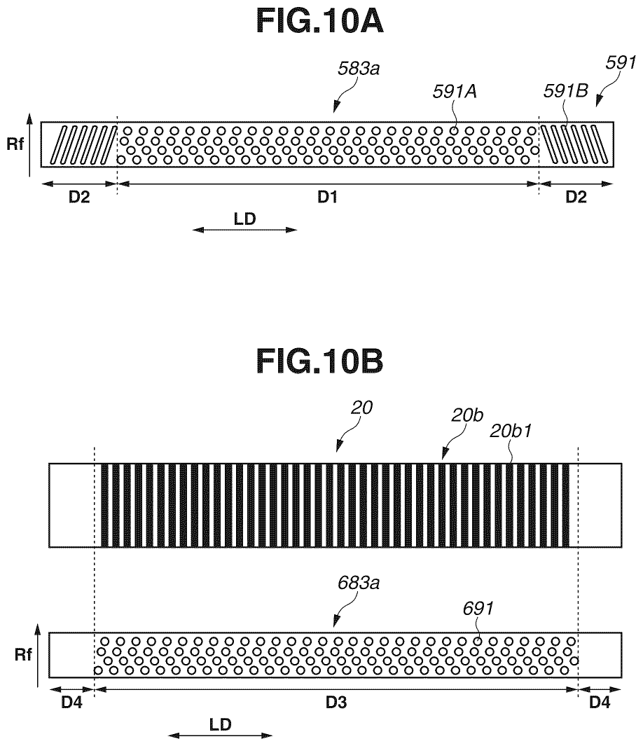

Next, a third embodiment of the present disclosure is described. The third embodiment is obtained by changing the pattern of the arrangement of the protruding portions 91 according to the first embodiment. Thus, components similar to those in the first embodiment are described by omitting the illustration of the components or designating the components by the same signs in the figures. The present embodiment is different from the first embodiment in that the arrangement is such that protruding portions 591 of a sliding contact portion 583a are not uniform and change along the longitudinal direction LD in the present embodiment, whereas the arrangement is such that the protruding portions 91 do not change in the first embodiment. With reference to FIG. 10A, the shapes of the protruding portions 591 of the sliding contact portion 583a according to the present embodiment are described. FIG. 10A is a diagram of the sliding contact portion 583a viewed from the pressure roller 82 side.

As illustrated in FIG. 10A, a sliding contact portion 583a includes a plurality of mountain-shaped second protruding portions 591A placed in a central region D1 in the longitudinal direction LD of the sliding contact portion 583a, and a plurality of slant-shaped first protruding portions 591B placed in end regions D2 in end portions in the longitudinal direction LD of the sliding contact portion 583a. The second protruding portions 591A are placed at positions closer to the center of the sliding contact portion 583a in the longitudinal direction LD than the first protruding portions 591B are, and have shapes different from those of the first protruding portions 591B. Each of the first protruding portions 591B extends toward a center of the sliding contact portion 583a in the longitudinal direction LD along the rotational direction Rf.

The first protruding portions 591B are placed at positions closer to the end portions of the sliding contact portion 583a than to the center of the sliding contact portion 583a in the longitudinal direction LD. In the present embodiment, the first protruding portions 591B are placed at the furthest positions from the center of the sliding contact portion 583a in the longitudinal direction LD among the plurality of protruding portions 591.

The slant-shaped first protruding portions 591B are provided in the end regions D2, whereby the lubricant 84 is prevented from leaking out of end portions in the longitudinal direction LD of the fixing film 20. The mountain-shaped second protruding portions 591A are provided in the central region D1, whereby the lubricant 84 is prevented from concentrating on the center in the longitudinal direction LD. As described above, the shapes and the arrangement of the protruding portions 591 are not uniform in the sliding contact portion 583a, and are changed along the longitudinal direction LD, whereby, in addition to the effect of leveling out thickness unevenness of the lubricant 84, a secondary effect such as preventing the lubricant 84 leakage or making appropriate distribution of the lubricant 84 is obtained.

Also in the present embodiment, the sliding contact portion 583a includes a groove portion which extends in a direction intersecting the rotational direction Rf and through which the lubricant 84 can pass. Consequently, thickness unevenness of the lubricant 84 is leveled out. Particularly, in the present embodiment, the interval La between adjacent protruding portions 591 viewed from upstream in the rotational direction Rf of the fixing film 20 is narrower than the pitch Lb of divided conductors 20bl of the fixing film 20. Consequently, thickness unevenness of the lubricant 84 is leveled out, and the occurrence of thickness unevenness of the lubricant 84 in the longitudinal direction LD on the inner circumferential surface of the fixing film 20 is prevented. Thus, the life of the fixing device 80 is extended.

As illustrated in FIG. 10B, the shapes of protruding portions 691 may be changed according to a region where the divided conductors 20b1 are present in the fixing film 20. FIG. 10B illustrates the relationship between the region where the divided conductors 20b1 are present in the fixing film 20 and a region where the protruding portions 691 are present in a sliding contact portion 683a.

When a recording material P passes through the fixing device 80, heat is not taken by the recording material P in a non-sheet passing region, and therefore, a temperature rise in a non-sheet passing portion occurs such that the temperature of the fixing film 20 is higher in the non-sheet passing region than in a sheet passing region. In a case where the divided conductors 20bl are not provided in end portions in the longitudinal direction LD of the fixing film 20 as illustrated in FIG. 10B for the purpose of, for example, preventing the temperature rise in the non-sheet passing portion, temperature unevenness of the lubricant 84 does not occur in the end portions. Thus, protruding portions 691 may be provided in a region D3 where the divided conductors 20b1 are present, whereas protruding portions 691 may not be provided in a region D4 where the divided conductors 20b1 are not present.

In a case where the intervals between the divided conductors 20b1 of the fixing film 20 are not regular in the longitudinal direction LD, the shapes and the arrangement of the protruding portions 691 may be changed in the longitudinal direction LD according to the intervals between the divided conductors 20b1. As described above, the shapes and the arrangement of the protruding portions 691 may be changed in the longitudinal direction LD according to the placement of the divided conductors 20b1 in the fixing film 20 or the corresponding purpose. The combination of the shapes and the arrangement of the protruding portions 691 when the shapes and the arrangement are changed in the longitudinal direction LD, regions where the shapes and the arrangement are changed, and the like are not limited to the above. Protruding portions 691 may be arranged having a variety of shapes in combination according to the purpose.

### Fourth Embodiment

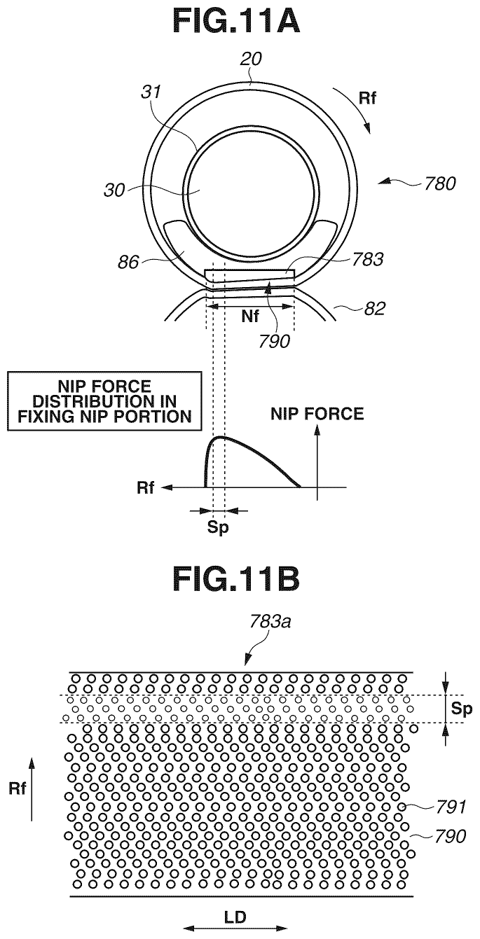

Next, a fourth embodiment of the present disclosure is described. The fourth embodiment is obtained by changing the pattern of the arrangement of the protruding portions 91 according to the first embodiment. Thus, components similar to those in the first embodiment are described by omitting the illustration of the components or designating the components by the same signs in the figures. The present embodiment is different from the first embodiment in that the arrangement is such that protruding portions 791 of a sliding contact portion 783a are not uniform and change along the rotational direction Rf in the present embodiment, whereas the arrangement is such that the protruding portions 91 do not change in the first embodiment. With reference to FIGS. 11A and 11B, the shapes of the protruding portions 791 of the sliding contact portion 783a according to the present embodiment are described. FIG. 11A illustrates a schematic cross-sectional view of a fixing device 780 and the nip force distribution in the fixing nip portion Nf.

The present embodiment is different from the first embodiment in the cross-sectional shape of a nip portion formation member 783. In the present embodiment, the thickness of the nip portion formation member 783 becomes thicker toward the downstream side in the rotational direction Rf of the fixing film 20, and a base surface 790 slopes to protrude toward the pressure roller 82. Through the use of the nip portion formation member 783 having such a shape, a high nip force is produced in, for example, a region Sp in a downstream portion of the fixing nip portion Nf as illustrated in the nip force distribution in the fixing nip portion Nf in FIG. 11A. Herein, the “nip force” refers to a force received from the pressure roller 82 by a sliding contact portion 783a regardless of the presence or absence of protruding portions and is a concept different from that of pressure per unit area. As described above, a high nip force acts in the downstream portion of the fixing nip portion Nf, to efficiently deform and melt toner on a recording material P in the state where the toner is sufficiently softened. Thus, fixability is improved. That is, the base surface 790 has such a shape that the amount of protrusion toward the pressure roller 82 in the region Sp (a second position) located downstream of an upstream portion (a first position) in the rotational direction Rf is greater than the amount of protrusion toward the pressure roller 82 in the upstream portion in the rotational direction Rf.

On the other hand, in the region Sp locally having a high nip force in the fixing nip portion Nf, the pressing force of the protruding portions 791 of the nip portion formation member 783 on the inner circumferential surface of the fixing film 20 is strong, and abrasion of the inner circumferential surface of the fixing film 20 may be promoted. Accordingly, in the present embodiment, as illustrated in FIG. 11B, the placement of the protruding portions 791 is not uniform in the sliding contact portion 783a and changes along the rotational direction Rf of the fixing film 20.

FIG. 11B is a diagram of the sliding contact portion 783a viewed from the pressure roller 82 side. In the present embodiment, similarly to the first embodiment, the plurality of mountain-shaped protruding portions 791 is provided in the sliding contact portion 783a, but the height of protruding portions 791 in the region Sp having a high nip force in the rotational direction Rf of the fixing film 20 is lower than the height of protruding portions 791 in regions other than the region Sp. That is, the amount of protrusion of the protruding portions 791 from the base surface 790 in the region Sp is less than the amount of protrusion of protruding portions 791 from the base surface 790 in the upstream portion. As described above, the height of the protruding portions 791 in the region Sp locally having a high nip force is lower than the height of the protruding portions 791 in the other regions, to prevent abrasion of the inner circumferential surface of the fixing film 20.

Although in the present embodiment, the heights of the protruding portions 791 are changed, the present disclosure is not limited to this. The shapes of the protruding portions 791, the intervals between the protruding portions 791, or the like may be changed, thereby preventing abrasion of the inner circumferential surface of the fixing film 20 in the region Sp. For example, the total area of a contact surface where the protruding portions 791 come into contact with the fixing film 20 in the region Sp may be great compared to those in the other regions. Protruding portions 791 may not be provided in the region Sp.

In the present embodiment, the heights of the protruding portions 791 are lower only in the region Sp having a high nip force than in the other regions, and the heights of the protruding portions 791 have two steps overall. The present disclosure, however, is not limited to this. The heights of the protruding portions 791 may not be changed only in the region Sp, and the heights, the shapes, the intervals, or the like of the protruding portions 791 may be changed step by step according to the nip force distribution in the fixing nip portion Nf. For example, in a case where the nip force distribution changes in the rotational direction Rf of the fixing film 20 as in the present embodiment, the stronger the nip force may be along the rotational direction Rf of the fixing film 20, the lower the heights of the protruding portions 791 may be. In a case where the nip force changes in the longitudinal direction LD, the shapes or the arrangement of the protruding portions 791 may be changed according to the nip force distribution in the longitudinal direction LD. As described above, the heights, the shapes, the intervals, or the like of the protruding portions 791 are changed according to the nip force distribution in the fixing nip portion Nf, to prevent the occurrence of abrasion of the inner circumferential surface of the fixing film 20 due to the protruding portions 791.

Also in the present embodiment, the sliding contact portion 783a includes a groove portion which extends in a direction intersecting the rotational direction Rf and through which the lubricant 84 can pass. Consequently, unevenness of the thickness of the lubricant 84 is leveled out. Particularly, in the present embodiment, the interval La between adjacent protruding portions 791 viewed from upstream in the rotational direction Rf of the fixing film 20 is narrower than the pitch Lb of divided conductors 20bl of the fixing film 20. Consequently, unevenness of the thickness of the lubricant 84 is leveled out, and the occurrence of thickness unevenness of the lubricant 84 is prevented in the longitudinal direction LD on the inner circumferential surface of the fixing film 20. Thus, the life of the fixing device 80 is extended.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-175930, filed Oct. 7, 2024, which is hereby incorporated by reference herein in its entirety.

What is claimed is:

1. A fixing device comprising:
a heating unit configured to heat a recording material on which a toner image has been formed, with the heating unit including a rotatable body and a nip portion formation member including a sliding contact portion, wherein an inner circumferential surface of the rotatable body is configured to slidingly contact the sliding contact portion; and
an opposing member opposed to the rotatable body and configured to rotate about a rotational axis extending in an axis direction, the opposing member and the rotatable body forming a nip portion with the nip portion formation member,
wherein the sliding contact portion of the nip portion formation member and the inner circumferential surface of the rotatable body are configured to include lubricant therebetween,
wherein the rotatable body includes a plurality of heating elements that are ring-shaped, with the plurality of heating elements being separated in the axis direction to form gaps between adjacent heating elements,
wherein the sliding contact portion includes a groove portion extending in a direction intersecting a rotational direction of the rotatable body, and wherein the groove portion is configured to allow passage of the lubricant.

2. The fixing device according to claim 1,
wherein the sliding contact portion includes a base surface opposed to the rotatable body and a plurality of protruding portions protruding from the base surface toward the opposing member, the plurality of protruding portions configured to come into contact with the rotatable body, and
wherein the groove portion is disposed between the base surface and the plurality of protruding portions.

3. The fixing device according to claim 2,
wherein each of the plurality of protruding portions is independently disposed at intervals in the axis direction and the rotational direction.

4. The fixing device according to claim 2, wherein each of the plurality of protruding portions includes a straight portion with a straight line shape extending in a direction intersecting both the axis direction and the rotational direction.

5. The fixing device according to claim 2,
wherein each of the plurality of protruding portions includes an upstream end and a downstream end in the rotational direction, and
wherein the downstream end of the protruding portion closer to a center of the sliding contact portion in the axis direction than the upstream end.

6. The fixing device according to claim 2, wherein at least a part of each protruding portion of the plurality of protruding portions overlaps two adjacent heating elements, viewed in a direction orthogonal to both the axis direction and the rotational direction.

7. The fixing device according to claim 2,
wherein each adjacent heating element of the plurality of heating elements is disposed at a predetermined pitch in the axis direction, and
wherein a minimum width of the groove portion is less than the predetermined pitch, viewed in the rotational direction.

8. The fixing device according to claim 2,
wherein each protruding portion of the plurality of protruding portions includes a first protruding portion that extends toward a center of the sliding contact portion in the axis direction along the rotational direction, and
wherein the first protruding portion is disposed closer to an end portion of the sliding contact portion than the center of the sliding contact portion.

9. The fixing device according to claim 8, wherein the first protruding portion is disposed at a position furthest from the center of the sliding contact portion in the axis direction among the plurality of protruding portions.

10. The fixing device according to claim 8, wherein each protruding portion of the plurality of protruding portions includes a second protruding portion disposed closer to the center of the sliding contact portion in the axis direction than the first protruding portion, the second protruding portion having a shape different from a shape of the first protruding portion.

11. The fixing device according to claim 2,
wherein a shape of the base surface corresponds to an amount of protrusion toward the opposing member at a second position downstream of the first position in the rotational direction that is greater than an amount of protrusion toward the opposing member at the first position, and
wherein an amount of protrusion from the base surface of the protruding portions at the second position is less than an amount of protrusion from the base surface of the protruding portions at the first position.

12. The fixing device according to claim 1, wherein each heating element of the plurality of heating elements is a conductor configured to generate heat due to induced electromotive force in a case where an alternating magnetic field is generated.

13. The fixing device according to claim 1, wherein each protruding portion of the plurality of protruding portions has an embossed structure.

14. An image forming apparatus comprising:
an image forming section configured to form a toner image on a recording material; and
the fixing device according to claim 1.

15. The fixing device according to claim 1, wherein the rotatable body is tubular.

16. A fixing device comprising:
a heating unit configured to heat a recording material on which a toner image has been formed; and
an opposing member, wherein:
the heating unit includes a rotatable body and a nip portion formation member,
the rotatable body includes a plurality of heating elements,
the nip portion formation member includes a sliding contact portion,
the nip portion formation member and the rotatable body form a nip portion,
the opposing member is opposed to the rotatable body and is configured to rotate about an axis extending in an axis direction,
the rotatable body includes a plurality of heating elements, and
adjacent heating elements of the plurality of heating elements are separated in the axis direction by gaps.

17. The fixing device of claim 16, wherein the sliding contact portion of the nip portion formation member and an inner circumferential surface of the rotatable body are configured to support lubricant therebetween.

18. The fixing device of claim 17, wherein the sliding contact portion of the nip portion formation member includes a groove portion extending in a direction intersecting a rotational direction of the rotatable body, and
wherein the groove portion is configured to allow passage of the lubricant.

19. The fixing device of claim 16, wherein the rotatable body is tubular shaped.

20. The fixing device of claim 16, wherein the plurality of heating elements are ring-shaped.
